(19) United States
(12) Patent Application Publication
(10) Pub. No.: US 2011/0055590 A1
(43) Pub. Date: Mar. 3, 2011

(54) APPARATUS AND METHOD FOR COLLECTING EVIDENCE DATA

(75) Inventors: Joo-Young LEE, Daejeon (KR); Su Hyung Jo, Daejeon (KR); Youn-Hee Gil, Daejeon (KR); Youngsoo Kim, Daejeon (KR); Keonwoo Kim, Daejeon (KR); Sang Su Lee, Daejeon (KR); Sung Kyong Un, Daejeon (KR); Do Won Hong, Daejeon (KR)

(73) Assignee: Electronics and Telecommunications Research Institute, Daejeon (KR)

(21) Appl. No.: 12/620,925

(22) Filed: Nov. 18, 2009

(30) Foreign Application Priority Data
Aug. 27, 2009 (KR) 10-2009-0079568

(51) Int. Cl. G06F 12/14; G06F 17/30

(52) U.S. Cl. 713/189; 707/709; 707/E17.115

(57) ABSTRACT

An apparatus for collecting evidence data includes: an online data collection unit for collecting online data from a location designated by a user; a screen capture unit for capturing shots viewed on a computer screen, as they are; a time stamping unit for calculating a message digest for the collected online data to generate a time stamp including date and time when the message digest has been generated and a signature of the time stamping unit itself; and an image generation unit for generating a forensic image for the collected online data and generating a message digest for the collected online data.

### CROSS-REFERENCE(S) TO RELATED APPLICATION(S)

The present invention claims priority of Korean Patent Application No. 10-2009-0079568, filed on Aug. 27, 2009, which is incorporated herein by reference.

### FIELD OF THE INVENTION

The present invention relates to an apparatus and method for collecting evidence data, and, more particularly, to an apparatus and method capable of securing admissibility of evidence for online data collected in information and communication environment in which storage medium is difficult to be acquired.

### BACKGROUND OF THE INVENTION

With the rapid development of Internet and network using a computer, digital materials related to personal communication, accounts and document information, which are essential data of corporations and facilities, are also increasingly computerizing.

The digital materials are easy to be created, copied, transmitted and deleted and also difficult to distinguish the original from the copy. Therefore, in order to have a legal admissibility of evidence, a special method and procedure are required in the whole process of collecting, storing, analyzing and reporting the materials.

In a variety of civil and criminal cases, an investigation using a digital material in information and communication environment is very important, but evidence data in such environment is easy to be forged and also securing admissibility of the evidence data is more difficult.

A procedure and method of securing legal admissibility of digital material are generically called ‘computer forensics’. The computer forensics is a technique proving a fact mainly based on digital material stored within a hard disk drive and the like of a computer. For example, when a crime related to a computer occurs, the computer forensics technique collects and analyzes evidence data to find a criminal. Till now, the evidence data was collected after a crime had occurred.

As a tool for computer forensics, there are a writing prevention block for providing effectiveness of digital material and an equipment for collecting evidence data using a cryptographic hash function. The writing prevention block may prevent a doubt on manipulation intended by investigator when an image of a hard disk drive confiscated as evidence is generated. The cryptographic hash function may prove an originality of generated forensic image.

FIG. 1 shows a block diagram of an apparatus for collecting evidence data using a writing prevention block. An apparatus for collecting evidence data 100 includes a writing prevention unit 101, an image generation unit 103, a compression unit 105, an encryption unit 107, and a storage unit 109.

The writing prevention unit 101 may be either embedded in the apparatus 100, or positioned outside the apparatus 100. When a crime related to the computer occurs, the writing prevention unit 101 may perform writing prevention function so that a hard disk drive S1, which is confiscated by the criminal investigation agency, cannot be overwritten. From this, it is proved that the hard disk drive S1 has not been manipulated during investigation.

The image generation unit 103 generates a forensic image by copying digital data stored in the hard disk drive S1 in a sector size set on physical level of the hard disk drive S1, and also generates a digest for the digital data using a hash algorithm while generating the forensic image. The digest and the forensic image are stored in the storage unit 109 or external storage unit S3.

Here, the digest may be compressed by the compression unit 105 or encrypted by the encryption unit 107.

The apparatus for collecting evidence data 100 described above may secure admissibility of evidence by guaranteeing a faultlessness of the hard disk drive S1. However, when web data on the Internet, online data given through a query in an enterprise database, or data within a large-scale shared disk are required for investigation, it is impossible for a hard disk drive to be physically acquired. In those cases, original data can be changed after being collected, and thus a problem on preservation of evidence may occur. If the data are presented as evidence in a trial, the data is difficult to be accepted as evidence since authenticity and effectiveness of the data are doubtful, thereby occurring a dispute for a possibility of manipulating the data.

### SUMMARY OF THE INVENTION

In view of the above, the present invention provides an apparatus for collecting evidence data and method for securing admissibility of evidence of data by performing a time stamp function and a screen capture function together or selectively, when an evidence medium containing the data such as a hard disk drive is difficult to be acquired.

In accordance with a first aspect of the present invention, there is provided an apparatus for collecting evidence data, including:

an online data collection unit for collecting online data from a location designated by a user;

a time stamping unit for calculating a message digest for the collected online data to generate a time stamp including date and time when the message digest has been generated and a signature of the time stamping unit itself; and

an image generation unit for generating a forensic image for the collected online data and generating a message digest for the collected online data.

In accordance with a second aspect of the present invention, there is provided a method for collecting evidence data, including:

collecting online data from a location designated by a user;

generating a time stamp for the online data by calculating a first message digest;

storing the time stamp and the collected online data;

generating a forensic image and a second message digest for the online data; and

storing the forensic image and the second message digest.

In accordance with a third aspect of the present invention, there is provided an apparatus for collecting evidence data, including:

an online data collection unit for collecting online data from a location designated by a user;

a screen capture unit for capturing shots viewed on a computer screen, as they are; and

an image generation unit for generating a forensic image for the collected online data and generating a message digest for the collected online data.

The apparatus for collecting evidence data further includes a time stamping unit for calculating a message digest for the collected online data to generate a time stamp including date and time when the message digest has been generated and a signature of the time stamping unit itself.

In accordance with a fourth aspect of the present invention, there is provided a method for collecting evidence data, including:

collecting online data from a location designated by a user;

capturing shots viewed on a computer screen;

converting the collected online data into an image file or a moving picture;

generating a message digest for the image file or the moving picture;

storing the image file or the moving picture with the message digest;

generating a forensic image and a message digest for the online data; and

storing the forensic image and the message digest for the online data.

The method for collecting evidence data further includes, after said generating the message digest for the image file or the moving picture, generating a time stamp for the online data and storing the time stamp.

### BRIEF DESCRIPTION OF THE DRAWINGS

The above features of the present invention will become apparent from the following description of embodiments given in conjunction with the accompanying drawings, in which:

FIG. 1 shows a block diagram of an apparatus for collecting evidence data using a writing prevention block.

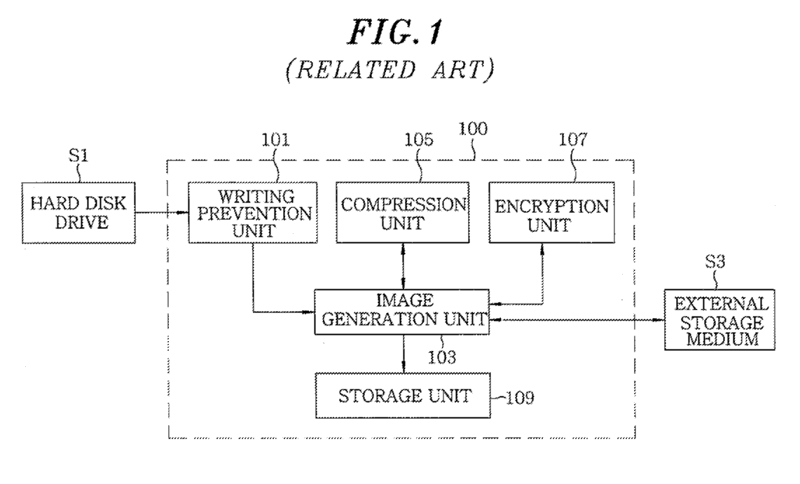

FIG. 2 is a block diagram illustrating an apparatus for collecting evidence data in accordance with a first embodiment of the present invention.

FIG. 3 is a flowchart showing a method for collecting evidence data in accordance with the first embodiment of the present invention.

FIG. 4 is a block diagram illustrating an apparatus for collecting evidence data in accordance with a second embodiment of the present invention.

FIG. 5 is a flowchart showing a method for collecting evidence data in accordance with the second embodiment of the present invention.

FIG. 6 is a block diagram illustrating an apparatus for collecting evidence data in accordance with a third embodiment of the present invention.

FIG. 7 is a flowchart showing a method for collecting evidence data in accordance with the third embodiment of the present invention.

### DETAILED DESCRIPTION OF THE EMBODIMENTS

Hereinafter, embodiments of the present invention will be described in detail with reference to the accompanying drawings. Like reference numerals identify like or similar elements throughout the specification, and therefore the same description about elements having a like reference numeral may be omitted.

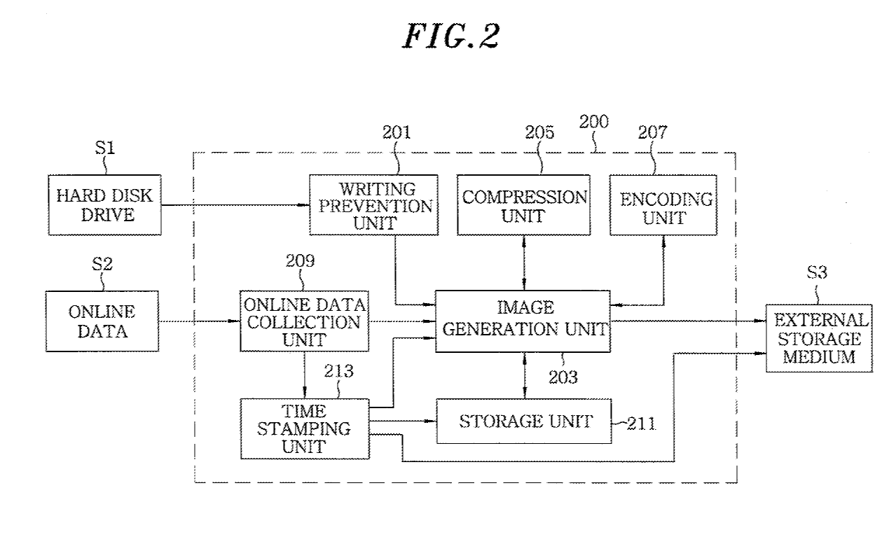

FIG. 2 is a block diagram illustrating an apparatus for collecting evidence data in accordance with a first embodiment of the present invention. An apparatus for collecting evidence data 200 includes a writing prevention unit 201, an image generation unit 203, a compression unit 205, an encryption unit 207, an online data collection unit 209, a storage unit 211 and a time stamping unit 213.

The writing prevention unit 201 may be embedded in the apparatus for collecting evidence data 200 or may be placed outside and connected to the apparatus 200. When a crime related to the computer occurs, if a hard disk drive S1 is acquired, the writing prevention unit 201 may perform writing prevention function so that the hard disk drive S1, which is confiscated by the criminal investigation agency, cannot be written. From this, it is proved that the hard disk drive S1 has not been manipulated during investigation.

In a case where the hard disk drive S1 is acquired, the image generation unit 203 is connected to the hard disk drive S1 through the writing prevention unit 201. The image generation unit 203 generates a forensic image by copying digital data stored in the hard disk drive S1, and generates a hash value, i.e., a message digest for the digital data using a hash algorithm. The message digest and the forensic image are stored in the storage unit 211 or in an external storage medium S3.

In a case where the hard disk drive S1 is not acquired, the image generation unit 203 generates a forensic image for online data collected by the online data collection unit 209 on a logical level. Also, the image generation unit 203 generates a message digest for the collected data using a hash function such as SHA1 (secure hash algorithm), MD5 (message digest) and the like. When the image generation unit 203 generates a forensic image for the online data, image generation information, e.g., a header of the image may include a time stamp generated by the time stamping unit 213 which will be described later.

The generated message digest is compressed by the compression unit 205 or encrypted by the encryption unit 207, depending on option.

The message digest and the forensic image are stored in the storage unit 211 or in the external storage medium S3.

The online data collection unit 209 may have a network communication function, a web crawling function and a device interface function and others, and checks a location designated by a user to collect online data S2.

In a case where the location is designated on the Internet web, the online data collection unit 209 collects data on the Internet web. At this time, the online data collection unit 209 may collect only data identified by a corresponding URI (uniform resource identifier), or may collect, additionally to those identified data, data of URI included within the identified data. Moreover, the online data collection unit 209 may also collect attached files and the like related to the URI.

In a case where the location is designated to a website requiring authentication, the online data collection unit 209 collects data by connecting to the website using a user's ID (identification) and password for authentication.

In a case where the location is designated to a system or a terminal connected to a workstation, database or the like, the online data collection unit 209 collects query data and files from the system or terminal using the device interface function.

The online data collected by the online data collection unit 209 from the designated location are provided to the time stamping unit 213 and the image generation unit 203.

The time stamping unit 213 generates a time stamp, which is composed of date and time when a message digest has been generated and a signature of the time stamping unit 213 itself, for the online data collected by the online data collection unit 209. The time stamp and the online data are stored in the storage unit 211 or in the external storage medium S3. Such a time stamp proves the fact that the data existed at a specific time. In detail, the time stamping unit 213 calculates a message digest for the collected online data using a security hash function to generate the time stamp. Here, the message digest is a data value formed of a short length of bit streams, e.g., 128 bits.

Such a time stamping unit 213 may be composed of a secret key; a clock keeping precise time, and electronic circuits or program codes which make it impossible to manipulate the time stamping unit 213. Additionally, the time stamping unit 213 may include a function for revising time when Daylight Saving Time (DST) is applied, and also may be connected to Time Stamping Authority (TSA) to obtain information required for generation of time stamps. As another implementation, the time stamping unit 213 may be connected to an external time stamp service to obtain time stamp from there.

In order to guarantee a security and faultlessness of the time stamp generated by the time stamping unit 213, the time stamp may be encrypted or a digest for the time stamp itself may be generated.

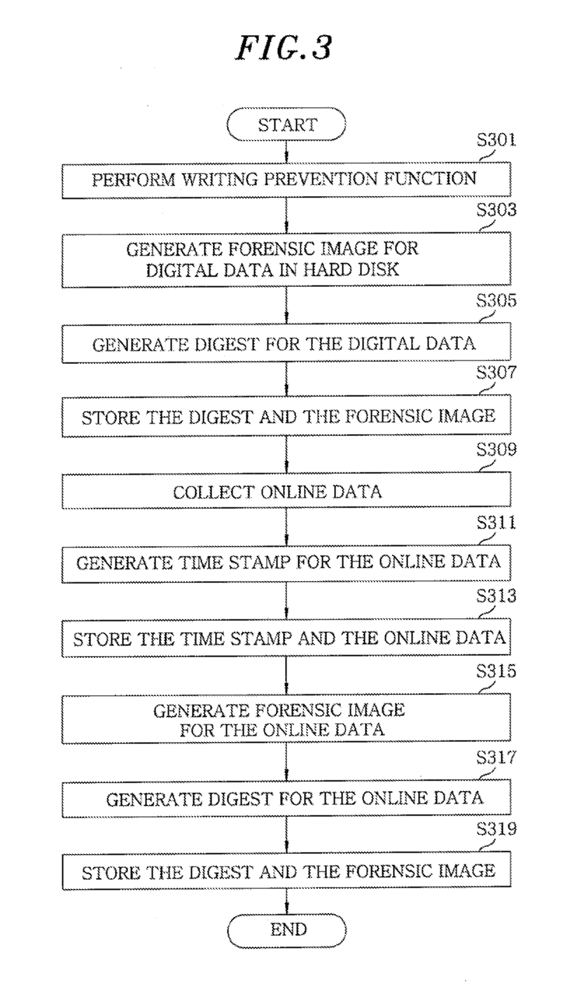

A process of collecting data in the apparatus for collecting evidence data 200 shown in FIG. 2 will be described with reference to FIG. 3 as follows.

FIG. 3 is a flowchart showing a method for collecting evidence data in accordance with the first embodiment of the present invention.

First, when an evidence medium, i.e., the hard disk drive S1 containing digital data for investigation is acquired, the writing prevention unit 201 performs writing prevention function so that the hard disk drive S1 cannot be overwritten in step S301. From this, it is proved that the hard disk drive S1 has not been manipulated during investigation.

The image generation unit 203 generates a forensic image for the digital data stored in the hard disk drive S1 by copying the digital data in step S303. Also, the image generation unit 203 generates a hash value, i.e. a digest for the digital data using a hash algorithm in step S305. Here, the digest may be compressed by the compression unit 205 or encrypted by the encryption unit 207. The digest and the forensic image are stored in the storage unit 211 or external storage medium S3 in step S307.

Meanwhile, when only online data for investigation is possible to be acquired as evidence, without an evidence medium containing the online data, the online data collection unit 209 of the apparatus for collecting evidence data 200 checks a location designated by a user to collect the online data from the designated position in step S309.

In more detail, if the location is designated on the Internet web, the online data collection unit 209 collects online data S2 on the Internet web. At this time, the online data collection unit 209 may collect only data identified by a corresponding URI (uniform resource identifier), or, additionally to those identified data, may collect data of URI included within the identified data. Moreover, the online data collection unit 209 may also collect attached files and the like related to the URI.

If the location is designated to a website requiring authentication, the online data collection unit 209 collects data by connecting to the website requiring authentication using a user's ID (identification) and password.

If the location is designated to a system or a terminal connected to a workstation, database or the like, the online data collection unit 209 collects query data and files from the system or terminal using the device interface function.

The online data collected by the online data collection unit 209 from the designated location are provided to the time stamping unit 213 and the image generation unit 203.

The time stamping unit 213 provided the collected online data calculates a message digest for the online data using a security hash function to generate a time stamp, which is composed of date and time when the message digest has been generated and a signature of the time stamping unit 213 in step S311. The time stamp and the provided online data are stored in the storage unit 211 or in the external storage medium S3 in step S313.

Next, the image generation unit 203 generates a forensic image for the online data collected by the online data collection unit 209 on a logical level in step S315. At this time, image generation information, e.g., a header of the forensic image may include the time stamp generated by the time stamping unit 213. Also, the image generation unit 203 generates a digest for the collected online data using a hash function such as SHA1, MD5 and the like in step S317. The digest and the forensic image are stored in the storage unit 211 or in the external storage medium S3 in step S319.

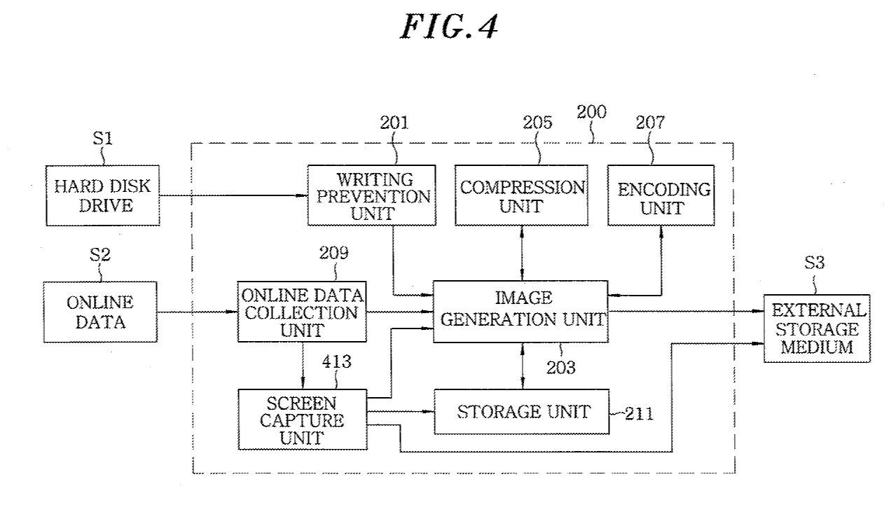

FIG. 4 is a block diagram illustrating an apparatus for collecting evidence data in accordance with a second embodiment of the present invention. The apparatus for collecting evidence data 400 includes a writing prevention unit 201, an image generation unit 203, a compression unit 205, an encryption unit 207, an online data collection unit 209, and a storage unit 211. And the apparatus 400 further includes a screen capture unit 413.

The apparatus for collecting evidence data 400 is substantially identical to the apparatus 200 shown in FIG. 2, except that the time stamping unit 213 of FIG. 2 is substituted with a screen capture unit 413. Therefore, detailed description for the identical components of the apparatus 400 will be omitted for the sake of simplicity of the present invention.

In the apparatus 400, collected online data by the online data collection unit 209 is delivered to the image generation unit 203 and to the screen capture unit 413.

The screen capture unit 413 captures shots viewed on a computer screen, as they are. Further, the screen capture unit 413 may convert the online data delivered from the online data collection unit 209 into an image file, e.g., any one of BMP, GIF, JPG, PNG, ICO, TIF and TGA file or may record the online data as a moving picture for a predetermined period of time. For instance, when investigation is only performed on query data collected from a large scale database system, screenshots during the process of collecting the query data may be recorded as a moving picture.

The captured shots and the image file or the moving picture are stored in the storage unit 211 or in the external storage unit S3.

Moreover, the screen capture unit 413 may generate a message digest for the image file or moving picture using a hash function and stores the message digest in the storage unit 211 or in the external storage unit S3. The message digest may be used to prove faultlessness of the corresponding file.

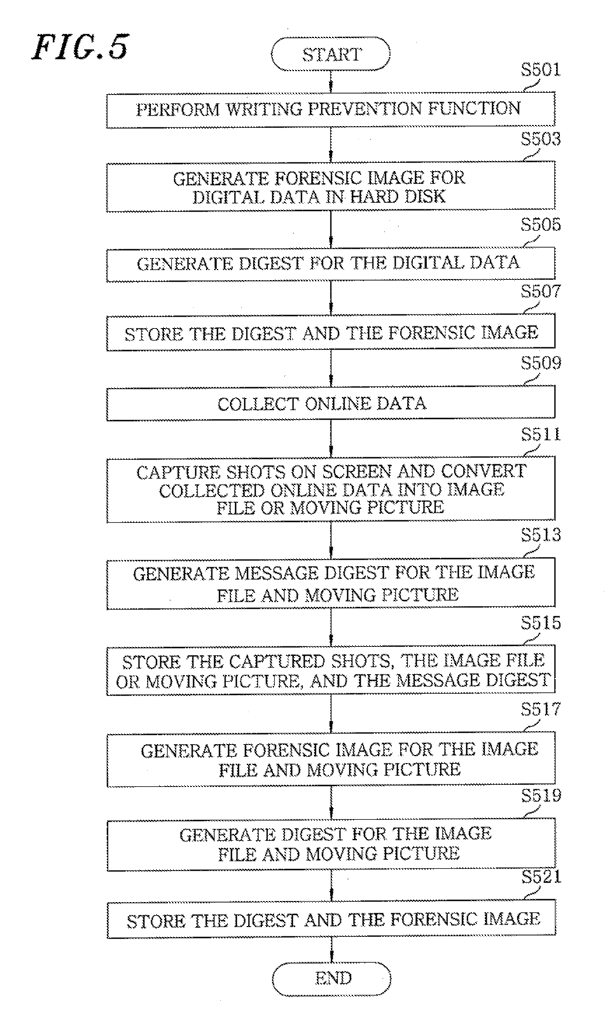

Next, a process of collecting data in the apparatus for collecting evidence data 400 shown in FIG. 4 will be described with reference to FIG. 5.

FIG. 5 shows a flow chart illustrating a method for collecting evidence data in accordance with the second embodiment of the present invention.

Referring to FIG. 5, steps S501 to 5509 of the second embodiment are identical to steps S301 to S309 of the first embodiment shown in FIG. 3, and therefore detailed description of steps S501 to S509 will be omitted.

Online data collected by the online data collection unit 209 in step S509 are provided to the screen capture unit 413 and the image generation unit 203.

The screen capture unit 413 captures shots viewed on a computer screen in step S511. Further, the screen capture unit 413 may convert the online data collected by the online data collection unit 209 into an image file or into a moving picture.

Thereafter, the screen capture unit 413 generates a message digest for the image file or moving picture using a hash function in step S513. The image file, the moving picture and the message digest are stored in the storage unit 211 or in the external storage unit S3 in step S515.

Thereafter, in steps S517 to S521, the image generation unit 203 performs the same procedure as in steps S315 to S319 shown in FIG. 3.

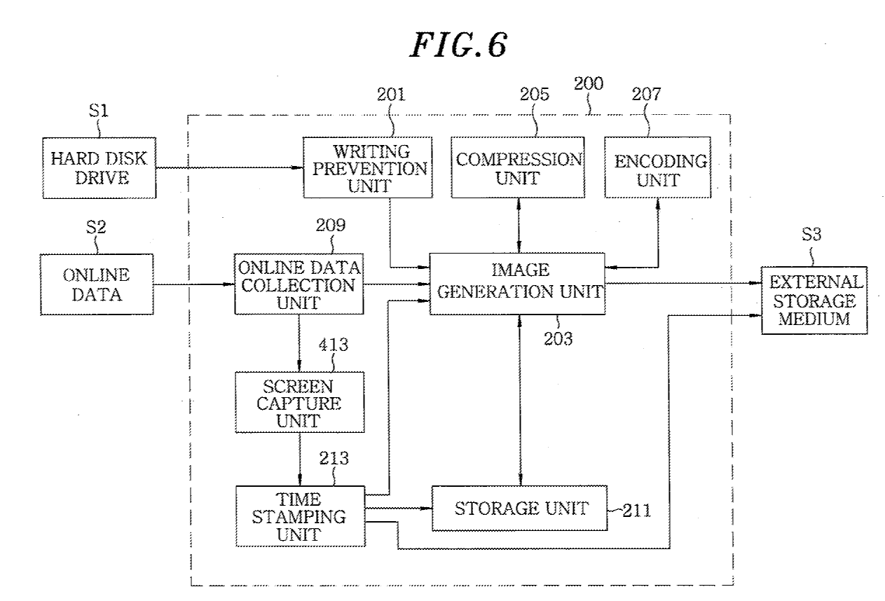

FIG. 6 shows a block diagram of an apparatus for collecting evidence data in accordance with a third embodiment of the present invention. The apparatus for collecting evidence data 600 is substantially identical to the apparatus 400 shown in FIG. 4, except that a time stamping unit 213 is further included. The time stamping unit 213 and the screen capture unit 413 perform the same functions as described in FIGS. 2 and 4, respectively. In brief, the time stamping unit 213 generates a time stamp for online data collected by the online data collection unit 209, and the screen capture unit 413 captures shots viewed on a computer screen, as they are.

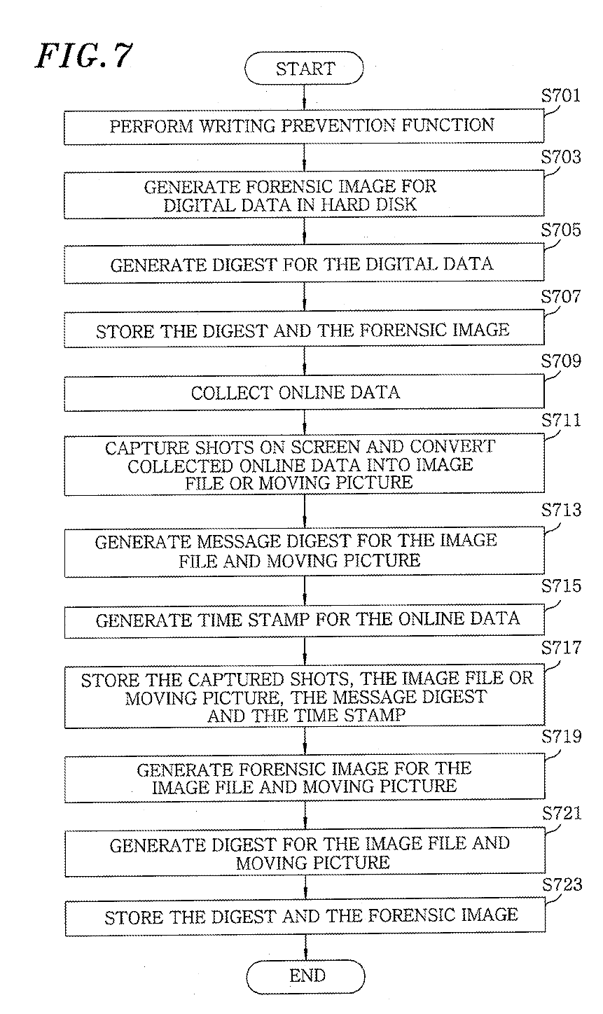

Next, a process of collecting data in the apparatus for collecting evidence data 600 shown in FIG. 6 will be described with reference to FIG. 7.

FIG. 7 is a flowchart showing a method for collecting evidence data in accordance with the third embodiment of the present invention.

Referring to FIG. 7, steps S701 to S713 of the third embodiment are identical to steps S501 to 5513 of the second embodiment shown in FIG. 5, and therefore detailed description of steps S701 to S713 will be omitted.

Captured shots, an image file or moving picture and a message digest generated by the screen capture unit 413 in steps S711 and S713 respectively is delivered to the time stamping unit 213 to be stored in the storage unit 211 or in the external storage medium S3.

Then, the time stamping unit 213 generates a time stamp, which is composed of date and time when the message digest has been generated and a signature of the time stamping unit 213, for the online data by calculating a message digest in step S715. The captured shots, the image file or moving picture and the message digest delivered from the screen capture unit 413 are stored with the time stamp in the storage unit 211 or in the external storage medium S3 in step S717.

Thereafter, in steps S719 to S723, the image generation unit 203 performs the same procedure as in steps S517 to S521 of FIG. 5.

As described above, the present invention may perform a time stamp function and a screen capture function together or selectively for online data in information and communication environment to secure admissibility of the online data. From this, the present invention may solve the conventional problem of causing doubt on manipulation of the online data

Moreover, when collecting online data, the present invention generates and stores a time stamp and also image file or moving picture of screenshots to prove that a specific data existed at a specific time, thereby guaranteeing originality and effectiveness of the evidence, i.e., the collected online data, and improving admissibility of the evidence.

While the invention has been shown and described with respect to the embodiments, it will be understood by those skilled in the art that various changes and modification may be made without departing from the scope of the invention as defined in the following claims.

What is claimed is:

1. An apparatus for collecting evidence data, comprising:
an online data collection unit for collecting online data from a location designated by a user;
a time stamping unit for calculating a message digest for the collected online data to generate a time stamp including date and time when the message digest has been generated and a signature of the time stamping unit itself; and
an image generation unit for generating a forensic image for the collected online data and generating a message digest for the collected online data.

2. The apparatus for collecting evidence data of claim 1, further comprising:
a writing prevention unit for preventing a hard disk drive acquired as evidence material from being written;
a compression unit for compressing the message digest generated by the image generation unit;
an encryption unit for encrypting the message digest generated by the image generation unit; and
a storage unit for storing the time stamp, the message digest generated by the image generation unit, and the forensic image.

3. The apparatus for collecting evidence data of claim 1, wherein when the location is designated on the Internet web, the online data are data identified by a corresponding URI (uniform resource identifier), data of URI included within the identified data in addition to those identified data, or attached files related to the URI, when the location is designated to a website requiring authentication, the online data are data collected by connecting to the website through authentication, and when the location is designated to a system or a terminal, the online data are query data and files collected from the system or terminal using a device interface function.

4. The apparatus for collecting evidence data of claim 1, wherein the message digest in the image generation unit is generated using a hash function, wherein the hash function is one of SHA (secure hash algorithm) and MD (message digest).

5. A method for collecting evidence data, comprising:
collecting online data from a location designated by a user;
generating a time stamp for the online data by calculating a first message digest;
storing the time stamp and the collected online data;
generating a forensic image and a second message digest for the online data; and
storing the forensic image and the second message digest.

6. The method for collecting evidence data of claim 5, wherein said collecting the online data includes:
when the location is designated on the Internet web, collecting only data identified by a corresponding URI (uniform resource identifier), collecting data of URI included within the identified data in addition to those identified data, or collecting attached files related to the URI;
when the location is designated to a website requiring authentication, collecting online data by connecting to the website through authentication; and
when the location is designated to a system or a terminal, collecting query data and files from the system or terminal using a device interface function.

7. An apparatus for collecting evidence data, comprising:
an online data collection unit for collecting online data from a location designated by a user;
a screen capture unit for capturing shots viewed on a computer screen, as they are; and
an image generation unit for generating a forensic image for the collected online data and generating a message digest for the collected online data.

8. The apparatus for collecting evidence data of claim 7, further comprising:
a writing prevention unit for preventing a hard disk drive acquired as evidence material from being written;
a compression unit for compressing the message digest generated by the image generation unit;
an encryption unit for encrypting the message digest generated by the image generation unit; and
a storage unit for storing the collected online data, the message digest generated by the image generation unit, and the forensic image.

9. The apparatus for collecting evidence data of claim 7, wherein when the location is designated on the Internet web, the online data are data identified by a corresponding URI (uniform resource identifier), data of URI included within the identified data in addition to those identified data, or attached files related to the URI, when the location is designated to a website requiring authentication, the online data are data collected by connecting to the website through authentication, and when the location is designated to a system or a terminal, the online data are query data and files collected from the system or terminal using a device interface function.

10. The apparatus for collecting evidence data of claim 7, wherein the screen capture unit converts the collected online data into an image file or a moving picture and generates a message digest for the image file or the moving picture.

11. The apparatus for collecting evidence data of claim 7, further comprising:
a time stamping unit for calculating a message digest for the collected online data to generate a time stamp including date and time when the message digest has been generated and a signature of the time stamping unit itself.

12. The apparatus for collecting evidence data of claim 11, further comprising:
a writing prevention unit for preventing a hard disk drive from being written;
a compression unit for compressing the message digest generated by the image generation unit;
an encryption unit for encrypting the message digest generated by the image generation unit; and
a storage unit for storing the time stamp, the message digest generated by the image generation unit, and the forensic image.

13. The apparatus for collecting evidence data of claim 11, wherein when the location is designated to the Internet web, the online data are data identified by a corresponding URI (uniform resource identifier), data of URI included within the identified data in addition to those identified data, or attached files related to the URI, when the location is designated to a website requiring authentication, the online data are data collected by connecting to the website through authentication, and when the location is designated to a system or a terminal, the online data are query data and files collected from the system or terminal using a device interface function.

14. The apparatus for collecting evidence data of claim 11, wherein the screen capture unit converts the collected online data into an image file or a moving picture and generates a message digest for the image file or the moving picture.

15. The apparatus for collecting evidence data of claim 11, wherein the message digest in the image generation unit is generated using a hash function, wherein the hash function is one of SHA (secure hash algorithm) and MD (message digest).

16. A method for collecting evidence data, comprising:
collecting online data from a location designated by a user;
capturing shots viewed on a computer screen;
converting the collected online data into an image file or a moving picture;
generating a message digest for the image file or the moving picture;
storing the captured shots and the image file or the moving picture with the message digest;
generating a forensic image and a message digest for the online data; and
storing the forensic image and the message digest for the online data.

17. The method for collecting evidence data of claim 16, further comprising:
after said generating the message digest for the image file or the moving picture,
generating a time stamp for the online data and storing the time stamp.

18. The method for collecting evidence data of claim 16, wherein said collecting the online data includes:
when the location is designated on the Internet web, collecting only data identified by a corresponding URI (uniform resource identifier), collecting data of URI included within the identified data in addition to those identified data, or collecting attached files related to the URI;
when the location is designated to a website requiring authentication, collecting online data by connecting to the website through authentication; and
when the location is designated to a system or a terminal, collecting query data and files from the system or terminal using a device interface function.

19. The method for collecting evidence data of claim 17, wherein said collecting the online data includes:
when the location is designated on the Internet web, collecting only data identified by a corresponding URI (uniform resource identifier), collecting data of URI included within the identified data in addition to those identified data, or collecting attached files related to the URI;
when the location is designated to a website requiring authentication, collecting online data by connecting to the website through authentication; and
when the location is designated to a system or a terminal, collecting query data and files from the system or terminal using a device interface function.
